(19) United States
(12) Patent Application Publication
(10) Pub. No.: US 2012/0064839 A1
(43) Pub. Date: Mar. 15, 2012

(54) FULLY INTEGRATED RADIO TRANSMITTER, RADIO COMMUNICATION DEVICE, AND METHOD OF TRANSMITTING RADIO SIGNAL

(76) Inventors: Jong-Ryul YANG, Seoul (KR); Hwa-Yeal YU, Bucheon-si (KR)

(21) Appl. No.: 13/229,209

(22) Filed: Sep. 9, 2011

(30) Foreign Application Priority Data
Sep. 15, 2010 (KR) 10-2010-0090608

(51) Int. Cl. H04B 1/40; H04B 1/04

(52) U.S. Cl. 455/76; 455/110

(57) ABSTRACT

A transmitter includes an input unit, a transmission phase locked loop PLL, a local PLL, and a synthesis unit. The input unit is configured to generate a division control signal based on an input signal and channel information. The transmission PLL is configured to generate a modulation signal having a frequency of a GHz band, which varies in response to the division control signal. The local PLL is configured to generate a local signal having the GHz band. The synthesis unit is configured to frequency-synthesize the modulation signal and the local signal to output a transmission signal of a MHz band.

### CROSS-REFERENCE TO RELATED APPLICATION

This application claims priority under 35 U.S.C. §119 to Korean Patent Application No. 10-2010-0090608 filed on Sep. 15, 2010, the disclosure of which is incorporated by reference in its entirety herein.

### BACKGROUND

1. Technical Field

Embodiments of the inventive concept relate to a fully integrated radio transmitter and a radio communication device having the same.

2. Discussion of Related Art

Radio is the transmission of signals by modulation of electromagnetic waves with frequencies below those of visible light. When radio waves pass an electrical conductor, the oscillating fields induce an alternating current in the conductor. The induced current can be detected and transformed into sound or other signals that carry information.

Radio communication devices can communicate using a particular frequency band. As the number of fields to which radio communication is applied increases, more and more bands of the available spectrum are used. A frequency modulation FM radio communication device can operate within a megahertz (MHz) band (e.g., 88 MHz to 108 MHz).

### SUMMARY

In accordance with an exemplary embodiment of the inventive concept, a transmitter includes an input unit, a transmission phase locked loop (PLL), a local PLL, and a synthesis unit. The input unit is configured to generate a division control signal based on an input signal and channel information. The transmission PLL generates a modulation signal having a frequency of a gigahertz (GHz) band which is varied in response to the division control signal. The local PLL generates a local signal having the GHz band. The synthesis unit frequency-synthesizes the modulation signal and the local signal and outputs a transmission signal of a MHz band.

The input unit may include an encoder configured to encode the input signal to output the encoded signal, and a modulator configured to modulate the encoded signal and the channel information to output the division control signal.

The transmission PLL may include a transmission reference frequency generator configured to generate a transmission reference frequency signal, a transmission divider configured to divide the modulation signal in response to the division control signal to output the divided modulation signal, a transmission phase frequency detector configured to output a transmission up signal or a transmission down signal according to a phase difference between the transmission reference frequency signal and the divided modulation signal, a transmission charge pump configured to supply or interrupt electric charge in response to the transmission up signal and the transmission down signal, a transmission loop filter configured to be charged or discharged to output a transmission control voltage according to electric charge supplied by the transmission charge pump, and a transmission voltage controlled oscillator (VCO) configured to output the modulation signal whose frequency is varied in response to the transmission control voltage. The interruption of the electric charge by the charge pump may cause the loop filter to discharge.

The local PLL may include a local reference frequency generator configured to generate a local reference frequency signal, a local divider configured to divide the local signal to output the divided local signal, a local phase frequency detector configured to output a local up signal or a local down signal according to a phase difference between the local reference frequency signal and the divided local signal, a local charge pump configured to supply or interrupt electric charge in response to the local up signal and the local down signal, a local loop filter configured to be charged or discharged to output a local control voltage according to electric charge supplied by the transmission charge pump, and a local VCO configured to output the local signal whose frequency is varied in response to the local control voltage.

The synthesis unit may include a frequency mixer configured to frequency-synthesize the modulation signal and the local signal to output an up-conversion signal having a frequency corresponding to a sum of a frequency of the modulation signal and a frequency of the local signal and a down-conversion signal having a frequency corresponding to a difference between the frequency of the modulation signal and the frequency of the local signal, and a first low-pass filter (LPF) configured to filter the up-conversion signal and the down-conversion signal output from the frequency mixer, and output the filtered down-conversion signal as the transmission signal.

The transmitter may be integrated in one chip.

In accordance with an exemplary embodiment of the inventive concept, a radio communication device includes a transmitter and receiver. The transmitter is configured to generate a modulation signal having a frequency of a GHz band which is varied in response to an input signal and channel information, by frequency-synthesizing the modulation signal and a local signal having a frequency of the GHz band, and outputting a transmission signal of a MHz band via an antenna. The receiver receives a reception signal via the antenna, and demodulates the reception signal to output an output signal.

The transmitter may include an input unit configured to generate a division control signal based on the input signal and the channel information, a transmission PLL configured to generate the modulation signal having the frequency of the GHz band which is varied in response to the division control signal, and a synthesis unit configured to frequency-synthesize the modulation signal and the local signal applied by the receiver, and output the transmission signal of the MHz band.

The receiver may include a reception amplifier configured to amplify the reception signal applied via the antenna to output the amplified signal, a local PLL configured to generate the local signal in response to the channel information, a first local signal divider configured to divide the local signal to output the divided local signal, a reception frequency mixer configured to frequency-synthesize the output signal of the reception amplifier and the divided local signal to output a frequency-synthesized signal, an LPF configured to filter the signal output from the reception frequency mixer and to output the filtered signal, a variable amplifier configured to variably amplify the signal output from the LPF and to output the amplified signal, a demodulator configured to demodulate the signal output from the variable amplifier, and to output a reception encoding signal, and a decoder configured to decode the reception encoding signal and to output the output signal.

In accordance with an exemplary of the inventive concept, a method of transmitting a radio signal in a transmitter having an input unit, a transmission PLL, a local PLL, and a synthesis unit includes generating a division control signal based on an input signal and channel information, generating a modulation signal having a frequency of a GHz band which is varied in response to the division control signal, generating a local signal having the GHz band, and frequency-synthesizing the modulation signal and the local signal to output a transmission signal of a MHz band. In an embodiment of the invention, the method can be executed by an apparatus such as a processor or stored as instructions on a non-transitory computer readable medium (e.g., a floppy disk, CD ROM, flash memory, etc.).

In accordance with an exemplary embodiment of the inventive concept a transmitter includes a first PLL, a second PLL, a frequency mixer, and a low pass filter. The first phase PLL is configured to generate a first signal having a frequency of a GHz band. The second PLL is configured to generate a second signal having the GHz band. The frequency mixer is configured to frequency-synthesize the first signal and the second signal to output a pair of signals. The low pass filter is configured to filter the pair of signals to output a transmission signal of a MHz band.

One of the signals of the pair may be a sum of the first signal and the second signal and the other of the pair may be a difference of the first signal and the second signal. The first PLL may include a VCO, a divider that divides an output of the VCO to output a divided signal, and a phase detector that outputs a phase difference signal that indicates whether a phase difference between a reference frequency and the divided signal. The transmitter may further include a charge pump and a loop filter. The charge pump may supply a charge to the loop filter or discharge a charge from the loop filter based on the phase difference signal. The transmitter may include a second divider that divides the second signal to generate the reference frequency. The transmitter may include a second low pass filter receiving an output of the first PLL and providing an output to the frequency mixer and a third low pass filter receiving an output of the second PLL and providing an output to the frequency mixer. The transmitter may include an encoder encoding an input signal to generate an encoded signal and a modulator to modulate the encoded signal and generate a modulated signal. The first signal may be a sum of a center frequency of the GHz band and the modulated signal having a frequency of the MHz band. The transmission signal may be based on a gain of the VCO multiplied by a gain of a VCO of the second PLL, and further multiplied by a gain of the frequency mixer.

### BRIEF DESCRIPTION OF THE DRAWINGS

Exemplary embodiments of the inventive concept are described in further detail below with reference to the accompanying drawings in which like reference characters refer to the same parts throughout the different views. The drawings may not be to scale. In the drawings:

FIG. 1 is a diagram showing an example of a transmitter in accordance with an exemplary embodiment of the inventive concept;

FIG. 2 is a diagram showing a frequency mixing process of the transmitter of FIG. 1;

FIG. 3 is a diagram showing an example of a transmitter in accordance with an exemplary embodiment of the inventive concept;

FIG. 4 is a diagram showing a frequency mixing process of the transmitter of FIG. 3;

FIG. 5 is a diagram showing an example of a transmitter in accordance with an exemplary embodiment of the inventive concept; and

FIG. 6 is a diagram showing an example of a radio communication device having the transmitter in accordance with an exemplary embodiment of the inventive concept.

### DETAILED DESCRIPTION

The inventive concept will now be described more fully with reference to the accompanying drawings in which exemplary embodiments thereof are shown. These inventive concepts may, however, may be embodied in different forms and should not be construed as limited to the embodiments set forth herein. In the drawings, the sizes and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present.

Embodiments of a fully integrated radio transmitter and a radio communication device having the same will now be described below with reference to the accompanying drawings.

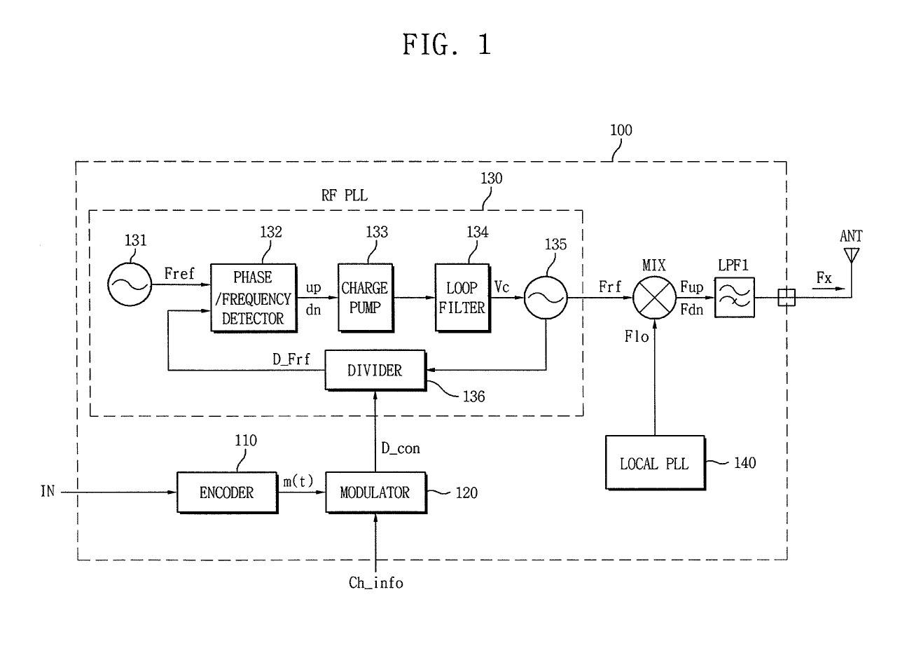

FIG. 1 is a diagram showing an example of a radio transmitter in accordance with an exemplary embodiment of the inventive concept. In accordance with an exemplary embodiment of the inventive concept, a transmitter 100 shown in FIG. 1 may be applicable to radio communication devices that operate within a MHz frequency band. While an example of an FM radio transmitter will be described below, embodiments of the inventive concept are not limited to FM radio transmitters. As described above, the FM radio transmitter is a device for transmitting a signal of an FM radio frequency band (e.g., 88 MHz to 108 MHz). However, embodiments of the inventive concept are not limited to any particular frequency band.

Referring to FIG. 1, the transmitter 100 includes an encoder 110, a modulator 120, two phase locked loops PLLs 130 and 140, a frequency mixer MIX, and a first low pass filter LPF LPF1. The encoder 110 receives an input signal IN from the outside, encodes the input signal IN into a signal that is capable of being modulated, and outputs an encoded signal m(t). The encoder 110 may generate the encoded signal m(t) using various methods. The modulator 120 receives and modulates the encoded signal m(t) and channel information Ch_info, and outputs a division control signal D_con. For example, a sigma-delta modulator may be used as the modulator 120 of FIG. 1.

The channel information Ch_info is information about a carrier wave for transmitting information of the input signal IN. For example, the channel information Ch_info may include a predetermined frequency band of the carrier wave. A carrier wave is a waveform that is modulated with an input signal for the purpose of conveying information. To facilitate information transmission, a radio communication device includes and transmits information to be transmitted in the carrier wave having the predetermined frequency band. The carrier wave has a frequency band defined according to each communication device as a signal for information transmission. Since an example in which the transmitter 100 is an FM radio transmitter is provided, a frequency designated from among frequencies of a band of 88 MHz to 108 MHz is used as a carrier wave. In FIG. 1, an example in which the modulator 120 separately receives the encoded signal m(t) and the channel information Ch_info has been illustrated, but the channel information Ch_info may be included in the input signal IN to be applied to the encoder 110.

The transmission PLL 130 outputs a modulation signal Frf whose frequency varies in response to the division control signal D_con output from the modulator 120. The modulation signal Frf has a center frequency of a gigahertz (GHz) band, and is a signal whose frequency varies by the division control signal D_con. The transmission PLL 130 includes a transmission reference frequency generator 131, a transmission phase frequency detector 132, a transmission charge pump 133, a transmission loop filter (LPF) 134, a voltage controlled oscillator (VCO) 135, and a transmission divider 136.

The transmission reference frequency generator 131 may be an oscillator, which generates and outputs a transmission reference frequency signal Fref having a fixed frequency. The transmission reference frequency generator 131 may generate transmission reference frequency signals Fref of various frequencies.

The transmission phase frequency detector 132 receives a divided modulation signal D_Frf output from the transmission divider 136 along with the transmission reference frequency signal Fref, and outputs a transmission up signal up or a transmission down signal dn to the transmission charge pump 133 in response to a phase difference between the transmission reference frequency signal Fref and the divided modulation signal D_Frf. For example, the transmission up signal up is generated if the phase of the transmission reference frequency signal Fref is ahead of the phase of the divided modulation signal D_Frf, and the transmission down signal dn is generated if the phase of the divided modulation signal D_Frf is ahead of the phase of the transmission reference frequency signal Fref.

In response to the transmission up signal up and the transmission down signal dn output from the transmission phase frequency detector 132, the transmission charge pump 133 charges an electric charge in the transmission loop filter 134, or discharges an electric charge charged from the transmission loop filter 134. When the transmission loop filter 134 is charged by the transmission charge pump 133, a level of a transmission control voltage Vc is raised and output. At the time of discharging, the level of the transmission control voltage Vc is lowered and output. For example, the transmission loop filter 134 may be implemented by an LPF, which has a capacitor to charge or discharge electric charge.

The transmission VCO 135 outputs the modulation signal Frf in response to the transmission control voltage Vc. The modulation signal Frf may be a signal having a center frequency of a GHz band, whose frequency is modulated in response to a control voltage that varies by the division control signal D_con applied to the transmission divider 136. Accordingly, the modulation signal Frf may be expressed as shown in Equation (1).

Frf=Fcr+Fm(t) (1)

For example, the modulation signal Frf may be expressed as a sum of a center frequency signal Fcr and a modulated encoded signal Fm(t). The modulated encoded signal Fm(t) may be a signal of a frequency band used by a radio communication device, where the center frequency signal Fcr is a signal of the GHz band. If the transmitter 100 is an FM radio transmitter, the modulated encoded signal Fm(t) may be a signal of a band of 88 to 108 MHz, where the center frequency signal Fcr may be a signal having a frequency of 1 GHz.

The transmission divider 136 receives the modulation Frf, adjusts a division ratio in response to the division control signal D_con applied from the modulator 120, divides the modulation signal Frf, and outputs the divided modulation signal D_Frf.

An oscillator that generates a frequency signal like the transmission VCO 135 may include an inductor and a capacitor. A frequency signal output from the oscillator may be in inverse proportion to a square of the inductance of the inductor and the capacitance of the capacitor provided in the oscillator. For example, if a frequency of the frequency signal output from the oscillator becomes low, the inductor and the capacitor constituting the oscillator should have a capacity proportional to the square. Accordingly, when the sizes of the inductor and the capacitor are rapidly increased, the oscillator may be integrated into a chip. Therefore, the transmission VCO 135 generates a modulation signal Frf having a frequency of the GHz band to enable the size of the oscillator to be decreased in accordance with an exemplary embodiment of the inventive concept.

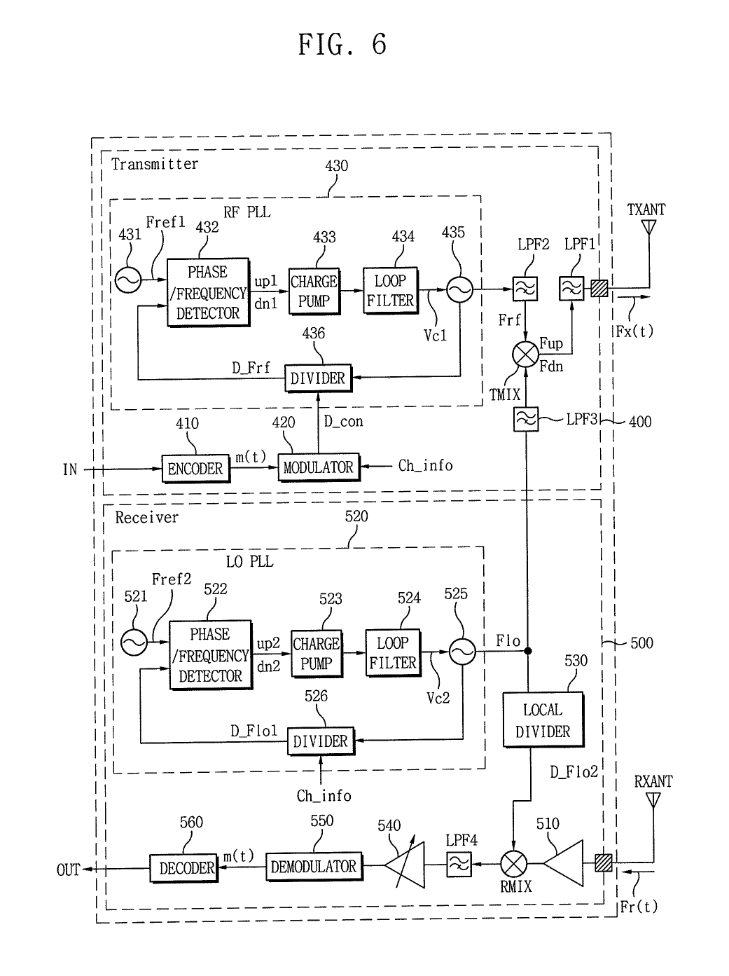

The local PLL 140 operates as a local oscillator, and generates a local signal Flo having a fixed frequency of a stable GHz band. The local PLL 140 may have the same configuration as a local PLL 520 shown in FIG. 6. The local PLL 140 may commonly use the transmission reference frequency generator 131 of the transmission PLL 130. The local signal Flo may have the same frequency as the center frequency signal Fcr of the transmission PLL 130.

The frequency mixer MIX receives and mixes the modulation signal Frf and the local signal Flo having the frequencies of the GHz band, and outputs a signal having a frequency of the carrier wave of the communication device as the center frequency. The signal output from the frequency mixer includes an up-conversion signal Fup and a down-conversion signal Fdn divided by characteristics of the mixer in a frequency domain as shown in Equation (2).

Fup=Frf+Flo=(Fcr+Flo)+Fm(t) Fdn=Frf−Flo=(Fcr−Flo)+Fm(t) (2)

As described above, the center frequency signal Fcr and the local signal Flo are respectively signals having frequencies of the GHz band, and Fm(t) is the signal having the frequency of the MHz band according to a used frequency band of the radio communication device. Accordingly, the up-conversion signal Fup is a signal of the GHz band since the center frequency signal Fcr and the local signal Flo are respectively signals of the GHz band. However, the transmitter 100 in accordance with an exemplary embodiment of the inventive concept is a transmitter for outputting a signal of the MHz band. Accordingly, the up-conversion signal Fup may be removed using a filter with passive elements. With respect to the down-conversion signal, a signal of a desired MHz band may be output by adjusting a frequency difference between the modulation signal Frf and the local signal Flo. Consequently, the transmission PLL 130 and the local PLL 140 respectively output signals of the GHz band, and the frequency mixer MIX may generate a signal of the MHz band to be transmitted by mixing the two signals of the GHz band output from the transmission PLL 130 and the local PLL 140.

A first LPF LPF1 filters the up-conversion signal Fup and the down-conversion signal Fdn output from the frequency mixer MIX, and outputs a transmission signal Fx(t) via an antenna ANT provided outside the transmitter 100. The transmission signal Fx(t) output via the antenna ANT can be expressed as shown in Equation (3).

Fx(t)=(Arfvco×Alovco×Amix)×exp[j2π(Fcr−Flo)+j2π∫₀^{t}fm(t)dt] (3)

Here, Arfvco denotes a gain of the transmission VCO 135 included in the transmission PLL 130, Alovco denotes a gain of the VCO included in the local PLL 140, and Amix denotes a gain of the frequency mixer MIX.

As described above, the transmitter 100 in accordance with an exemplary embodiment of the inventive concept generates the signal of the MHz band to be transmitted by mixing the modulation signal Frf and the local signal Flo of the GHz band. Accordingly, since a small-sized VCO for generating the signal of the GHz band is used rather than a VCO for directly generating the signal of the MHz band, all circuits of the transmitter 100 may be integrated.

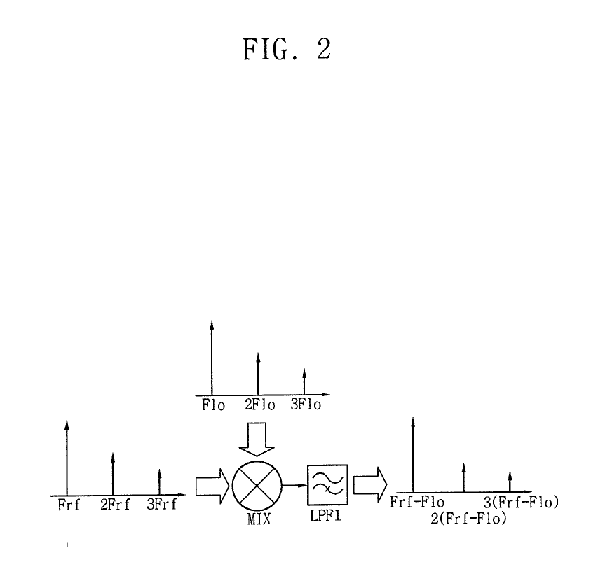

FIG. 2 is a diagram showing a frequency mixing process of the transmitter of FIG. 1. The frequency mixing process of the transmitter of FIG. 1 will be described with reference to FIG. 2. The transmission VCO 135 of the transmission PLL 130 outputs the modulation signal Frf. However, harmonics having frequencies of integer multiples of the modulation signal Frf are generated together when the transmission VCO 135 generates the modulation signal Frf. For example, as shown in FIG. 2, the transmission VCO 135 generates harmonics 2Frf, 3Frf, . . . corresponding to the integer multiples of the modulation signal along with the modulation signal Frf. However, the modulation signal Frf is a signal of the GHz band. Accordingly, the frequencies of the harmonics 2Frf, 3Frf, . . . output by the VCO 135 along with the modulation signal Frf are higher than that of a necessary frequency signal of the MHz band.

Likewise, a local VCO of the local PLL 140 also generates harmonics 2Flo, 3Flo, . . . corresponding to integer multiples of the local signal Flo along with the local signal Flo. Since the local signal Flo is also a signal of the GHz band, the harmonics 2Flo, 3Flo, . . . of the local signal Flo also have significantly high frequencies.

Like the transmission VCO 135 and the local VCO, the frequency mixer MIX also outputs harmonics 2(Frf-Flo), 3(Frf-Flo), . . . having frequencies of integer multiples of the down-conversion signal Fdn along with the down-conversion signal Fdn. The frequency mixer MIX outputs the up-conversion signal Fup as well as the down-conversion signal Fdn, and also outputs harmonics of the up-conversion signal Fup. However, since the frequency of the up-conversion signal Fup is a frequency sum of the modulation signal Frf and the local signal Flo, which are signals of the GHz band, and the harmonics of the up-conversion signal Fup are frequencies of integer multiples of the up-conversion signal Fup, the harmonics have significantly high frequencies.

Since the harmonics may cause the transmitter to generate noise, the harmonics should be removed. Since frequency differences between an output signal and harmonics of the output signal are on the order of several hundred KHz even when the frequency differences are large, a transmitter that outputs a radio signal of the MHz band may require a high-quality filter to remove the harmonics. However, use of a high-quality filter increases a manufacturing cost and makes size reduction difficult. Accordingly, it can be difficult to integrate both the VCO and a filter for removing noise caused by harmonics into a transmitter.

However, frequency differences between the down-conversion signal Fdn from the transmitter 100 in accordance with an exemplary embodiment of the inventive concept and the harmonics of the down-conversion signal Fdn as shown in FIG. 2 are the same as the magnitude of the down-conversion signal Fdn having a frequency of the MHz band. Accordingly, the transmitter 100 may remove the harmonics using the first LPF LPF1. Since the first LPF LPF1 need not be of a high quality, the first LPF LPF1 may include passive elements.

Consequently, since the sizes of the transmission VCO 135, the local VCO, and the first LPF LPF1 are significantly small, all elements of the transmitter may be integrated into a chip.

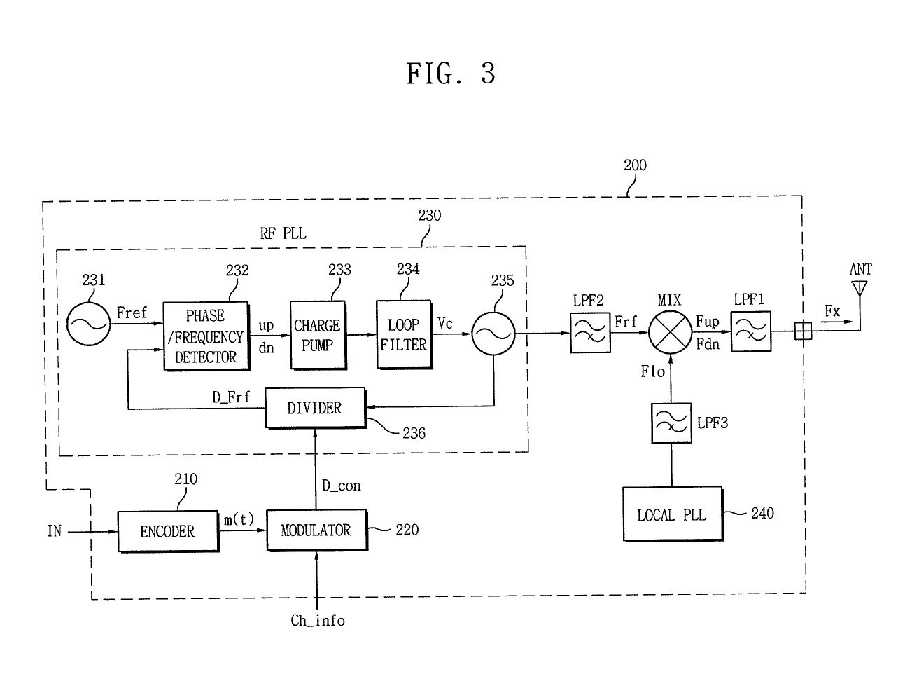

FIG. 3 is a diagram showing an example of a transmitter in accordance with an exemplary embodiment of the inventive concept. Referring to FIG. 3, the transmitter 200 includes an encoder 210, a modulator 220, transmission PLL 230, a local PLL 240, a first LPF LPF1, a second LPF LPF2, a third LPF LPF3, a mixer MIX, and an antenna ANT. The transmission PLL 230 includes a transmission reference frequency generator 231, a phase frequency detector 232, a charge pump 233, a loop filter 234, a voltage controlled oscillator (VCO) 235, and a divider 236. The elements of the transmitter 200 that are the same as the elements of the transmitter 100 may perform similar functions.

As compared to the transmitter of FIG. 1, the transmitter 200 of FIG. 3 includes the two additional LPFs LPF2 and LPF3. The second LPF LPF2 receives and filters a modulation signal Frf output from a transmission PLL 230, and outputs the filtered signal to a frequency mixer MIX. The third LPF LPF3 receives and filters a local signal Flo output from a local PLL 240, and outputs the filtered signal to the frequency mixer MIX.

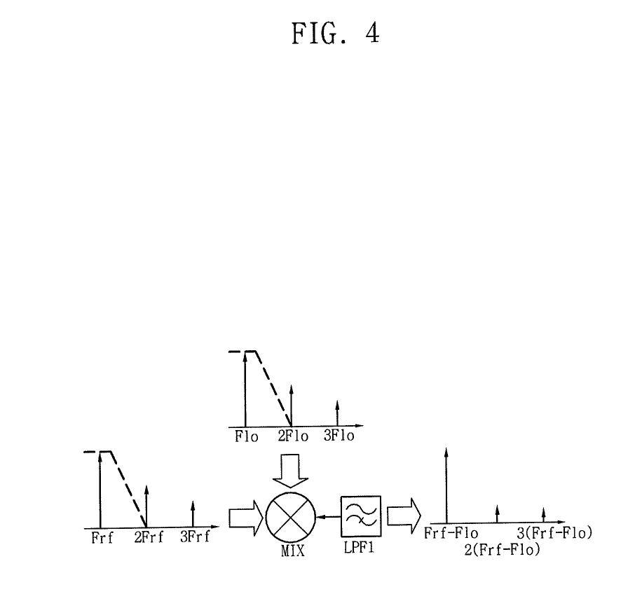

FIG. 4 is a diagram showing a frequency mixing process of the transmitter of FIG. 3.

The frequency mixing process of FIG. 4 will be described with reference to FIGS. 3 and 4. A transmission VCO 235 of the transmission PLL 230 generates harmonics 2Frf, 3Frf, . . . corresponding to integer multiples of the modulation signal along with the modulation signal Frf. The second LPF LPF2 applies only the modulation signal Frf to the frequency mixer MIX by receiving and low-pass filtering the modulation signal Frf and the harmonics 2Frf, 3Frf, . . . of the modulation signal. Since the modulation signal Frf is a signal of the GHz band and differences between the modulation signal Frf and the harmonics 2Frf, 3Frf, . . . of the modulation signal are equal to or greater than a GHz as described above, the harmonics 2Frf, 3Frf, . . . of the modulation signal may be removed using the second LPF LPF2 having passive elements.

Similarly, a local VCO of the local PLL 240 generates the harmonics 2Flo, 3Flo, . . . corresponding to integer multiples of the local signal Flo along with the local signal Flo. The third LPF LPF3 applies only the local signal Flo to the frequency mixer MIX by receiving and low-pass filtering the local signal Flo and the harmonics 2Flo, 3Flo, . . . of the local signal. Since the local signal Flo is a signal of the GHz band like the modulation signal Frf and differences between the local signal Flo and the harmonics 2Flo, 3Flo, . . . of the local signal are equal to or greater than a GHz, the harmonics 2Flo, 3Flo, . . . of the local signal may be removed using the third LPF LPF3 having passive elements.

For example, the two LPFs LPF2 and LPF3 respectively remove the harmonics of the modulation signal output from the transmission PLL and the harmonics of the local signal output from the local PLL. Accordingly, harmonic components of the down-conversion signal Fdn output from the frequency mixer MIX are also attenuated. Thereafter, the harmonic components are mostly removed from a transmission signal Fx(t) since the first LPF LPF1 filters and outputs the down-conversion signal Fdn.

As described above, the transmitter in accordance with an exemplary embodiment of the inventive concept may significantly attenuate the harmonics and reduce power consumption when the 3 LPFs LPF1, LPF2, and LPF3 include passive elements.

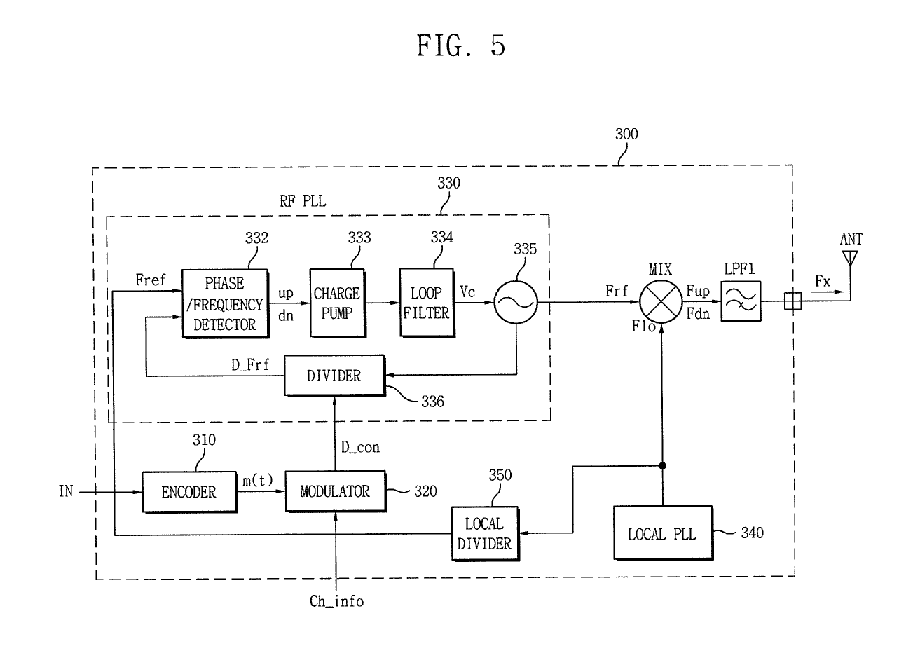

FIG. 5 is a diagram showing an example of a transmitter in accordance with an exemplary embodiment of the inventive concept. Referring to FIG. 5, the transmitter 300 includes an encoder 310, a modulator 320, transmission PLL 330, a local PLL 340, a local divider 350, a first LPF LPF1, a mixer MIX, and an antenna ANT. The transmission PLL 330 includes a phase frequency detector 332, a charge pump 333, a loop filter 334, a voltage controlled oscillator (VCO) 335, and a divider 336. The elements of the transmitter 300 that are the same as the elements of the transmitter 100 may perform similar functions.

The transmitter 300 of FIG. 5 includes a local (signal) divider 350 since the local PLL 340 outputs a local signal Flo. The local (signal) divider 350 divides the local signal Flo. The divided local signal is used as a reference frequency signal Fref. Accordingly, a transmission reference frequency generator 131 may be omitted from the transmitter 300, and thus the size of the transmitter 300 may be further reduced.

FIG. 6 is a diagram showing an example of a radio communication device having a transmitter in accordance with an exemplary embodiment of the inventive concept. Only the transmitters 100, 200, and 300 are shown in FIGS. 1, 3, and 5, but the radio communication device of FIG. 6 includes both a transmitter 400 and a receiver 500. Referring to FIG. 6, the transmitter 400 includes an encoder 410, a modulator 420, a PLL 430, a first LPF LPF1, a second LPF2, a third LPF3, a mixer TMIX, and an antenna TXANT. The PLL 430 may include a reference frequency generator 431, a phase frequency detector 432, a charge pump 433, a loop filter 434, and a voltage controlled oscillator (VCO) 435.

Different from the transmitters 100, 200, and 300 shown in FIGS. 1, 3, and 5, the transmitter 400 of FIG. 6 does not include a local PLL and receives a local signal Flo output from a local PLL 520 of receiver 500. For example, a transmission frequency mixer TMIX of the transmitter 400 of FIG. 6 mixes a modulation signal Frf, which is output from a transmission PLL 430 and applied through a second LPF LPF2, with the local signal Flo, which is output from the local PLL 520 provided in the receiver 500 and applied through a third LPF LPF3, and outputs an up-conversion signal Fup and a down-conversion signal Fdn to a first LPF LPF1. Since the rest of the transmitter 400 is the same as that of the transmitter 200 of FIG. 3, description thereof is omitted.

The receiver 500 of the radio communication device includes a reception amplifier 510, the local PLL 520, a local divider 530, a reception frequency mixer RMIX, a fourth LPF LPF4, a variable amplifier 540, a demodulator 550, and a decoder 560. The receiver 500 receives a transmission signal output from an external transmitter having the same frequency band as the reception signal as well as a transmission signal Fx(t) output from the transmitter 400 of the radio communication device.

The reception amplifier 510 amplifies a reception signal Fr(t) applied via an external receiving antenna RXANT, and outputs the amplified signal to the reception frequency mixer RMIX. Like the transmission PLL 430, the local PLL 520 includes a local reference frequency generator 521, a local phase frequency detector 522, a local charge pump 523, a local loop filter 524, a local VCO 525, and a local divider 526.

The local reference frequency generator 521 generates and outputs a local reference frequency signal Fref2 having a fixed frequency. The local phase frequency detector 522 receives a first divided local signal D_Flo1 output from the local divider 526 along with the local reference frequency signal Fref2, generates a local up signal up2 or a local down signal dn2 corresponding to a phase difference between the local reference frequency signal Fref2 and the first divided local signal D_Flo1, and outputs the local up signal up2 or the local down signal dn2 to the local charge pump 523. In response to the local up signal up2 and the local down signal dn2 output from the local phase frequency detector 522, the local charge pump 523 charges an electric charge in the local loop filter 524 or discharges electric charge from the local loop filter 524. When the local loop filter 524 is charged by the local charge pump 523, a level of a local control voltage Vc2 is raised and output. When discharging, the local control voltage Vc2 is lowered and output. In response to the local control voltage Vc2, the local VCO 525 outputs the local signal Flo. In response to channel information Ch_info, the local divider 526 divides the local signal Flo, and outputs a first divided local signal D_Flo1 to the local phase frequency sensor 522. Since the local PLL 520 outputs the local signal Flo set by the channel information Ch_info, the divider 526 outputs the first divided local signal D_Flo1 in response to the applied channel information Ch_info.

The local signal Flo output from the local PLL 520 is applied to the transmission frequency mixer TMIX of the transmitter 400, and is also applied to the local (signal) divider 530 of the receiver 500. The local (signal) divider 530 divides the local signal Flo, generates a second divided local signal D Flo2, and outputs the second divided local signal D_Flo2 to the reception frequency mixer RMIX. The second divided local signal D_Flo2 is a signal that may be generated to remove a carrier wave from a reception signal Fr(t).

The reception frequency mixer RMIX removes the carrier wave from the reception signal Fr(t) by synthesizing the reception signal Fr(t) amplified by the reception amplifier 510 and the second divided local signal D_Flo2. A fourth LPF LPF4 outputs a signal by removing harmonics occurring in a process of synthesizing the amplified reception signal Fr(t) and the second divided local signal D_Flo2 by the reception frequency mixer RMIX. The variable amplifier 540 variably amplifies and outputs the signal output by the fourth LPF LPF4, and the demodulator 550 receives and demodulates the variably amplified signal and outputs a reception encoding signal m(t) as a digital signal. The decoder 560 decodes the reception encoding signal m(t) and outputs an output signal OUT.

In the radio communication device of FIG. 6, the transmitter 400 frequency-mixes the modulation signal Frf with the local signal Flo output from the local PLL 520 provided in the receiver 500. Accordingly, since the transmitter 400 has only one PLL 430, which differs from the transmitters 100, 200, and 300 of FIGS. 1, 3, and 5, the size of the transmitter 400 may be significantly reduced and both the transmitter 400 and the receiver 500 may be integrated into a chip in the radio communication device.

Like the transmitter 300 of FIG. 5, the transmitter 400 of FIG. 6 may also generate a transmission reference frequency signal Fref1 by receiving and dividing the local signal Flo. For example, the transmission phase PLL 430 may include an additional divider, which generates the transmission reference frequency signal Fref1 by dividing the local signal Flo, without using the transmission reference frequency generator 431.

While FIG. 6 shows a transmitting antenna TXANT and a receiving antenna RXANT, in an alternate embodiment, one antenna may perform all functions of the transmitting antenna TXANT and the receiving antenna RXANT.

At least one embodiment of the inventive concept allows a transmitter to be fully integrated and to suppress noise caused by harmonics since two GHz band signals are generated and synthesized and a transmission signal of a MHz band is generated. Further, a system configuration may be simplified by sharing a PLL, which generates a signal of a GHz band upon transmission/reception according to an exemplary embodiment of the inventive concept.

Although exemplary embodiments of the inventive concept have been described, many modifications can be made to these embodiments without departing from the inventive concept. Therefore, it is to be understood that the foregoing is illustrative of various embodiments and is not to be construed as limited to the specific embodiments disclosed, and that modifications to the disclosed embodiments, as well as other embodiments, are intended to be included within the scope of the disclosure.

What is claimed is:

1. A transmitter comprising:
an input unit configured to generate a division control signal based on an input signal and channel information;
a transmission phase locked loop PLL configured to generate a modulation signal having a frequency of a GHz band, where the frequency is varied in response to the division control signal;
a local PLL configured to generate a local signal having the GHz band; and
a synthesis unit configured to frequency-synthesize the modulation signal and the local signal to output a transmission signal of a MHz band.

2. The transmitter according to claim 1, wherein the input unit comprises:
an encoder configured to encode the input signal to output an encoded signal; and
a modulator configured to modulate the encoded signal and the channel information to output the division control signal.

3. The transmitter according to claim 1, wherein the transmission PLL comprises:
a transmission reference frequency generator configured to generate a transmission reference frequency signal;
a transmission divider configured to divide the modulation signal in response to the division control signal to output the divided modulation signal;
a transmission phase frequency detector configured to output a transmission up signal or a transmission down signal according to a phase difference between the transmission reference frequency signal and the divided modulation signal;
a transmission charge pump configured to supply or discharge an electric charge in response to the transmission up signal and the transmission down signal;
a transmission loop filter configured to be charged or discharged by the charge pump to output a transmission control voltage; and
a transmission voltage controlled oscillator VCO configured to output the modulation signal whose frequency is varied in response to the transmission control voltage.

4. The transmitter according to claim 1, wherein the local PLL comprises:
a local reference frequency generator configured to generate a local reference frequency signal;
a local divider configured to divide the local signal to output a divided local signal;
a local phase frequency detector configured to output a local up signal or a local down signal according to a phase difference between the local reference frequency signal and the divided local signal;
a local charge pump configured to supply or discharge an electric charge in response to the local up signal and the local down signal;
a local loop filter configured to be charged or discharged by the local charge pump to output a local control voltage; and
a local VCO configured to output the local signal whose frequency is varied in response to the local control voltage.

5. The transmitter according to claim 4, wherein the transmission PLL comprises:
a local signal divider configured to divide the local signal to output a transmission reference frequency signal;
a transmission divider configured to divide the modulation signal in response to the division control signal to output the divided modulation signal;
a transmission phase frequency detector configured to output a transmission up signal or a transmission down signal according to a phase difference between the transmission reference frequency signal and the divided modulation signal;
a transmission charge pump configured to supply or discharge an electric charge in response to the transmission up signal and the transmission down signal;
a transmission loop filter configured to be charged or discharged by the transmission charge pump to output a transmission control voltage; and
a transmission VCO configured to output the modulation signal whose frequency is varied in response to the transmission control voltage.

6. The transmitter according to claim 1, wherein the synthesis unit comprises:
a frequency mixer configured to frequency-synthesize the modulation signal and the local signal to output an up-conversion signal having a frequency corresponding to a sum of a frequency of the modulation signal and a frequency of the local signal and a down-conversion signal having a frequency corresponding to a difference between the frequency of the modulation signal and the frequency of the local signal; and
a first low pass filter LPF configured to filter the up-conversion signal and the down-conversion signal output from the frequency mixer, and output the filtered down-conversion signal as the transmission signal.

7. The transmitter according to claim 6, wherein the synthesis unit further comprises:
a second LPF configured to filter the modulation signal output from the transmission PLL, and output the filtered modulation signal to the frequency mixer; and
a third LPF configured to filter the local signal output from the local PLL, and output the filtered local signal to the frequency mixer.

8. The transmitter according to claim 1, wherein the transmitter is integrated in one chip.

9. A radio communication device comprising:
a transmitter configured to generate a modulation signal having a frequency of a GHz band which is varied in response to an input signal and channel information, frequency-synthesize the modulation signal and a local signal having a frequency of the GHz band, and output a transmission signal of a MHz band via an antenna; and
a receiver configured to receive a reception signal via the antenna and demodulate the reception signal to output an output signal.

10. The radio communication device according to claim 9, wherein the transmitter comprises:
an input unit configured to generate a division control signal based on the input signal and the channel information;
a transmission phase locked loop PLL configured to generate the modulation signal having the frequency of the GHz band which is varied in response to the division control signal; and
a synthesis unit configured to frequency-synthesize the modulation signal and the local signal applied by the receiver, and output the transmission signal of the MHz band.

11. The radio communication device according to claim 10, wherein the receiver comprises:
a reception amplifier configured to amplify the reception signal applied via the antenna to output the amplified signal;
a local PLL configured to generate the local signal in response to the channel information;
a first local signal divider configured to divide the local signal to output a divided local signal;
a reception frequency mixer configured to frequency-synthesize the output signal of the reception amplifier and the divided local signal to output the frequency-synthesized signal;
a low pass filter LPF configured to filter the signal output from the reception frequency mixer and to output a filtered signal;
a variable amplifier configured to variably amplify the signal output from the LPF to output an amplified signal;
a demodulator configured to demodulate the signal output from the variable amplifier, and to output a reception encoding signal; and
a decoder configured to decode the reception encoding signal to output the output signal.

12. The radio communication device according to claim 9, wherein the radio communication device is integrated in one chip.

13. A transmitter comprising:
a first phase locked loop PLL configured to generate a first signal having a frequency of a GHz band;
a second PLL configured to generate a second signal having the GHz band;
a frequency mixer configured to frequency-synthesize the first signal and the second signal to output a pair of signals; and
a low pass filter configured to filter the pair of signals to output a transmission signal of a MHz band.

14. The transmitter of claim 13, where one of the signals of the pair is a sum of the first signal and the second signal and the other of the pair is a difference of the first signal and the second signal.

15. The transmitter of claim 13, wherein the first PLL comprises:
a voltage controlled oscillator VCO;
a divider that divides an output of the VCO to output a divided signal; and
a phase detector that outputs a phase difference signal that indicates a phase difference between a reference frequency and the divided signal.

16. The transmitter of claim 15, further comprising:
a charge pump; and
a loop filter,
wherein the charge pump performs one of supplying a charge to the loop filter or discharging a charge from the loop filter based on the phase difference signal.

17. The transmitter of claim 13, further comprising a second divider that divides the second signal to generate the reference frequency.

18. The transmitter of claim 13, further comprising:
a second low pass filter receiving an output of the first PLL and providing an output to the frequency mixer; and
a third low pass filter receiving an output of the second PLL and providing an output to the frequency mixer.

19. The transmitter of claim 13, further comprising:
an encoder encoding an input signal to generate an encoded signal; and
a modulator to modulate the encoded signal and generate a modulated signal, wherein the first signal is a sum of a center frequency of the GHz band and the modulated signal having a frequency of the MHz band.

20. The transmitter of claim 15, wherein the transmission signal is based on a gain of the VCO multiplied by a gain of a VCO of the second PLL, and further multiplied by a gain of the frequency mixer.
